(19) United States
(12) Patent Application Publication
(10) Pub. No.: US 2010/0149232 A1
(43) Pub. Date: Jun. 17, 2010

(54) System and Method for Identifying a Particular Inkjet Ink

(76) Inventor: Xiaorong Cai, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/336,391

(22) Filed: Dec. 16, 2008

(51) Int. Cl. B41J 29/38

(52) U.S. Cl. 347/7

(57) ABSTRACT

A system for identifying a particular inkjet ink includes an ink delivery tubing interconnecting an ink cartridge and a printhead, a quantity of ink dispensing from the ink cartridge to the printhead by flowing through the ink delivery tubing, a light emitter configured and positioned to transmit light in a first preselected wavelength bandwidth onto the ink delivery tubing and the ink flowing therethrough, a photo sensor configured and positioned to detect light in a different second preselected wavelength bandwidth that is emitted by a fluorescent additive contained in the dispensed ink, and a signal analyzer electrically connected to the photo sensor and operable to produce an electrical output signal corresponding to such light emissions such that an electrical output signal above a given level is indicative of the presence of the particular ink in the ink cartridge.

### CROSS-REFERENCE TO RELATED APPLICATIONS

This patent application is related to the following copending U.S. patent applications assigned to the assignee of the present invention: (1) Ser. No. 11/934,142, filed Nov. 2, 2007, entitled “Ink Identification And Detection System With Ink For Use Therewith”; (2) Ser. No. 11/835,682, filed Aug. 8, 2007, entitled “Fluorescent-Wax Emulsion For Pigment Ink Detection”; and (3) Ser. No. 11/774,628 filed Jul. 9, 2007, entitled “Printhead Auto-Alignment Detection System That Uses A Printed Printhead Alignment Pattern Containing Fluorescing Material”. Disclosures of these applications are incorporated by reference.

### BACKGROUND

1. Field of the Invention

The present invention relates generally to ink compositions used in inkjet imaging printheads and, more particularly, to a system and method for identifying a particular inkjet ink.

2. Description of the Related Art

An inkjet imaging system, such as an inkjet printing system, forms an image on a print medium by ejecting ink from a plurality of ink jetting nozzles of an inkjet printhead to form a pattern of ink dots on the print medium. Inkjet printing is accomplished without contact between the printing system and the print medium. Such printing system typically includes a semi-permanent printhead and one or more ink cartridge in which the ink supplied to the printhead is stored. The ink cartridge may be replaced once consumed during the printing operation.

U.S. Pat. Nos. 5,656,071 & 6,646,024, assigned to the assignee of the present invention, indicate an ongoing recognition that different ink compositions can differently affect print quality and printer maintenance problems. Thus, the composition of inks used in an inkjet printing system has been of long-standing concern to the manufacturer of the inkjet printing systems as well as the consumer who expects the inks they purchase to use with their inkjet printing systems to be of a certain quality. Hence, there is a need for a way to identify whether the particular composition of ink is actually being employed in an inkjet printing system.

It is known from U.S. Pat. No. 6,293,143 (hereinafter the “143” patent) also assigned to the assignee of the present invention, to add fluorescent material to ink to assist in sensing a low ink level in an ink cartridge. The ink level sensing apparatus of this patent is employed in association with an ink cartridge having an ink chamber containing ink and substantially insoluble fluorescent material in the ink. The fluorescent material has a specific gravity which is sufficiently lower than the ink such that the fluorescent material floats at or near the surface of the ink to provide an interface between it and the ink.

The apparatus of the '143 patent includes a light source, such as a light emitting diode (LED), for emitting substantially visible light of a first wavelength bandwidth along a light path through a substantially transparent side panel of the cartridge adjacent the ink chamber. The apparatus of this patent also includes a photo sensor, such as a phototransistor, for detecting light emissions from the fluorescent material in the ink excited by the light of the first wavelength bandwidth when the material crosses the light path, the detected light emissions from the fluorescent material being of a second wavelength bandwidth different from and higher than the first wavelength bandwidth.

The apparatus of the '143 patent further includes a filter between the fluorescent material and the photo sensor for blocking light within the first wavelength bandwidth emitted by the light emitter and passing light within the second wavelength bandwidth such as emitted by the fluorescent material. The primarily visible light emitted by the light emitter and received by the photo sensor has to travel through the transparent wall of the ink cartridge in going to and from the fluorescent material in the ink in the cartridge. A digital output signal generated by the photo sensor is sent to a printer control to signal a low ink level alarm which may be an audible or visible signal, a message on a computer monitor, etc., or a signal to terminate printing operations.

However, this approach is concerned with sensing when an ink cartridge is almost empty by detecting the presence of an interface between the ink and a non-soluble fluorescent material. This approach is not concerned with sensing a given level of emissions from a fluorescent material in order to identify the ink about to be used nor concerned whether the ink should or should not be used in the first instance in an inkjet printing system. Thus, the need remains for an approach to identify whether a particular composition of ink is about to be used in an inkjet printing system.

### SUMMARY OF THE INVENTION

The present invention meets this need by providing an innovation that is oriented to identifying a particular ink from an ink cartridge used in conjunction with an ink tubing delivery system. By successfully exciting and sensing fluorescence emissions of a given level from ink in an ink delivery tube the particular ink is detected in the ink delivery tubing before it is used in the inkjet printing system. Detecting inks from the ink delivery tubing will avoid the need for modification of the printhead or ink cartridge, thereby reducing the cost by simplifying the ink identification system. Instead, the present invention takes advantage of the existence of the ink delivery tubing system to detect particular inks when the inks are flowing through the delivery tubing. No cartridge or hardware modifications are required when detecting inks from the delivery tubing.

Accordingly, in an aspect of the present invention, a system for identifying an inkjet ink includes an ink delivery tubing interconnecting an ink cartridge and a printhead, a quantity of ink dispensed from the ink cartridge to the printhead by flowing through the ink delivery tubing, a light emitter configured and positioned to transmit light in a first preselected wavelength bandwidth onto the ink delivery tubing and the ink flowing therethrough, a photo sensor configured and positioned to detect light in a different second preselected wavelength bandwidth that is emitted by a fluorescent additive contained in the dispensed ink, and a signal analyzer electrically connected to the photo sensor and operable to produce an electrical output signal corresponding to such light emissions such that an electrical output signal above a given level is indicative of the presence of the particular ink in the ink cartridge.

In another aspect of the present invention, a method for identifying an inkjet ink includes dispensing ink from an ink cartridge to a printhead by the ink flowing through an ink delivery tubing interconnecting the ink cartridge to the printhead, transmitting light in a first preselected wavelength bandwidth onto the ink delivery tubing and the ink flowing therethrough, detecting light in a different second preselected wavelength bandwidth emitted by a fluorescent additive contained in the dispensed ink, and producing an electrical output signal corresponding to such light emissions such that an electrical output signal above a given level is indicative of the presence of the particular ink in the ink cartridge.

### BRIEF DESCRIPTION OF THE DRAWINGS

Having thus described the invention in general terms, reference will now be made to the accompanying drawings, which are not necessarily drawn to scale, and wherein:

FIG. 1 is a diagram of an embodiment of a system for identifying a particular inkjet ink according to the present invention.

FIG. 2 is a graph of electrical signal levels generated by emissions detected from various black inks with and without significant amounts of an invisible fluorescent dye.

FIG. 3 is a graph of electrical signal levels generated by emissions detected from various magenta inks with and without significant amounts of an invisible fluorescent dye.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

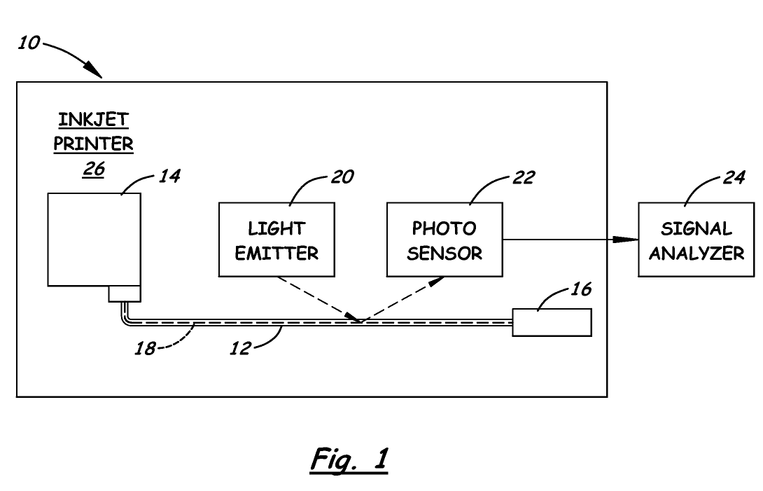

Referring now to FIG. 1, there is illustrated an exemplary embodiment of a system of the present invention, generally designated 10, for identifying an inkjet ink includes an ink delivery tubing 12 interconnecting an ink cartridge 14 and a printhead 16, and a quantity of ink 18 dispensing from the ink cartridge 14 to the printhead 16 by flowing through the ink delivery tubing 12. The materials of the tubing 12 may be plastic clear transparent tubing, such as PVC, polyethylene, polypropylene, EVA, polyurethane, and thermoplastic rubber tubing. The tubing materials should not have any fluorescent additives such as optical brightener and the materials should not block or filter the wavelengths of the emissions from the fluorescent materials used in the present invention which are described below.

The system 10 of the present invention further includes a light emitter 20 configured and positioned to transmit light in a first preselected wavelength bandwidth onto the ink delivery tubing 12 and the ink 18 flowing therethrough, a photo sensor 22 configured and positioned to detect light in a second preselected wavelength bandwidth different from the first preselected wavelength bandwidth emitted by a fluorescent additive contained in the ink 18, and a signal analyzer 24 electrically connected to the photo sensor 22 and operable to produce an electrical output signal corresponding to such light emissions such that an electrical output signal above a given level is indicative of the presence of the ink 18 in the ink cartridge 14. The light emitter 20 can be a single LED with a peak wavelength that is the same as or very close to the exciting wavelength of the fluorescent additive employed. The peak wavelength of this LED may be in the UV region (for example, 365 nm). The photo sensor 22 may have a filter to allow the fluorescent emission only. Thus, the photo sensor 22 would see all inks equally well at the specific wavelength, that of the peak emission from the preselected fluorescent additives. The system 10 is mounted on components of an inkjet printer 26 or in the near vicinity thereof such that every time when an ink cartridge 14 is installed into the printer, the ink 18 starts to flow via the tubing 12 to the printhead 16.

Thus, the present invention is premised on there being a preselected amount of fluorescent additive present in the ink 18 that is detectable in order to identify the presence of a particular ink in the ink cartridge 14. An invisible fluorescent material is processed to form a stable water-based dispersion and added to and mixed uniformly with the ink 18. This added material has a narrow absorbing wavelength bandwidth and narrow emitting wavelength bandwidth such that when the light within the narrow absorbing bandwidth excites on the ink 18, the signal within the narrow emitting bandwidth comes only or mainly from the added fluorescent material. None or very little comes from the ink itself. For example, a fluorescent material could be added that absorbs light in the non-visible spectrum of light (below 400 nm—UV) and re-emits light in the visible or near-IR spectrum of light (about 400 nm to 1000 nm). This fluorescent material can be invisible or visible within the visible spectrum. It would absorb light in the UV bandwidth and re-emit light in the visible or near-IR range of about 400 nm-1000 nm.

The fluorescent additive may be an invisible UV fluorescent dye or pigment processed with polymeric dispersants to form stable dispersion. The UV fluorescent colorant absorbs UV light from UV LED light emitter 20 in the wavelength range of between 250 nm to 400 nm, for example, 365 nm, and emits fluorescent light in visible wavelength range of between 400 nm to 780 nm, for example, peak at 505 nm for invisible green dye and peak at 549 nm for invisible yellow dye. The fluorescent emission is detected by the phototransistor of photo sensor 22. Suitable fluorescent dyes include various inorganic and organic fluorescent dyes, such as solvent dyes, disperse dyes, acid dyes, basic dyes, with the requirement that they have an excitation with UV or visible light in the wavelength range of 250 nm to 480 nm and have emission in the visible wavelength range from 400 nm to 780 nm. Fluorescent pigments can be either inorganic or organic pigments with the same excitation and emission requirements as the fluorescent dyes. The dyes and pigments can have color in visible light which requires them to be used in inkjet ink of a similar color, but the dyes or pigments are preferably considered invisible when in visible light. Invisible dyes or pigments typically have a white to off white color and will not affect the color properties of the inks in which they are added thereto.

Examples of invisible dyes and pigments that can be used are the Keyfluor® invisible dyes and pigments from Keystone Aniline Corporation, invisible dyes and pigments from Dayglo, invisible pigments from Optonix Inc. and invisible dyes and pigments from RiskReactor. Some examples of specific fluorescent dyes used in the present invention are Keyfluor® invisible green OB-505 which has an excitation with UV and visible light in the wavelength range from 250 nm to 400 nm and has an emission within a wavelength range from 450 nm to 650 nm and a peak at 505 nm. Another fluorescent dye is Keyfluor® invisible yellow OB-549 which has an excitation with UV and visible light in the wavelength range from 250 nm to 420 nm and has an emission within a wavelength range of from 520 nm to 620 nm and a peak at 549 nm. The dyes and pigments are not meant to limit the scope of the present invention. Any fluorescent dye or pigment which meets the requirement of the excitation and emission wavelength ranges can be used in the present invention.

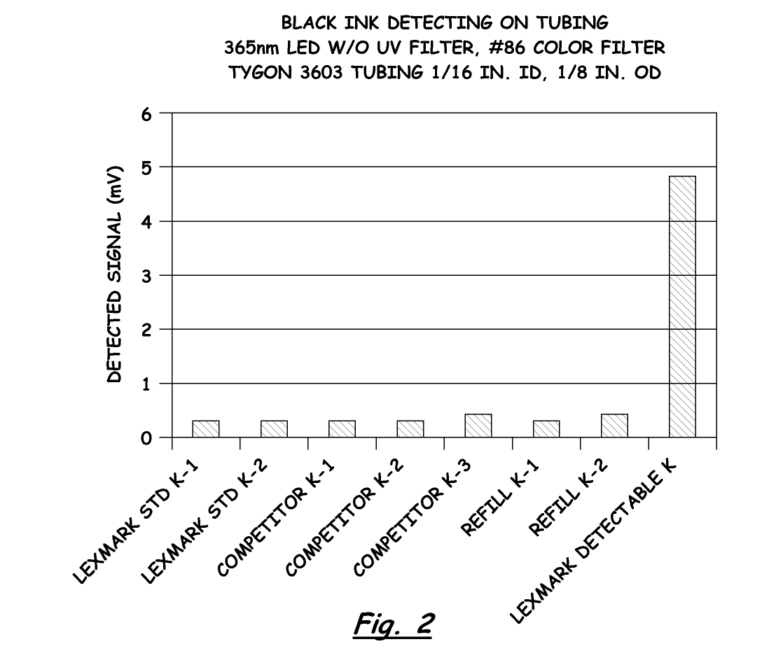

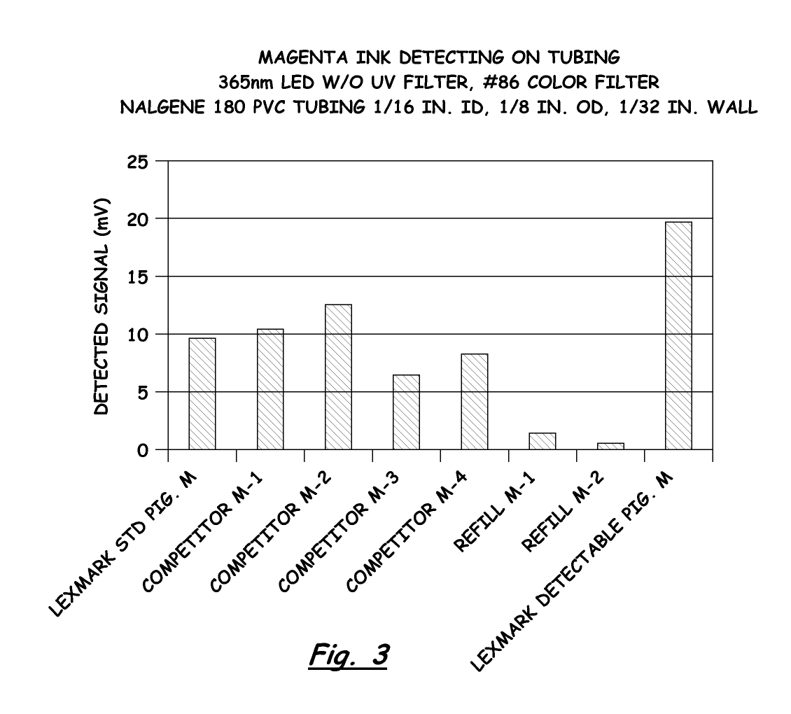

The following examples are of different black and magenta inks with and without fluorescent additives tested using the system and method of the present invention. FIGS. 2 and 3 depict the results of testing the inks in respective following Examples I and II. These examples are presented for illustrative purposes only, and are not intended as a restriction on the scope of the present invention.

### EXAMPLES

### System Employed

As seen in FIG. 1, the system 10 employed in testing included the light emitter 20 in the form of a 365 nm UV LED, the photo sensor 22 in the form of a phototransistor with a color filter, and a signal analyzer 24 in the form of a multi-meter used for signal level determination in the examples. The selected color filter used in this system was color filter #86 manufactured by Rosco Laboratories, Inc. Also, system 10 included the plastic tubing 12. The plastic tubing 12 used in testing Example I was Tygon 3606 plastic tubing with 1/16 in. inner diameter, 1/32 in. wall and ⅛ in. outer diameter. The plastic tubing 12 used in testing Example II was Nalgene 180 PVC tubing with 1/16 in. inner diameter, 1/32 in. wall and ⅛ in. outer diameter.

Testing Methods:

Ink in the plastic tubing 12 absorbs the UV light from the LED light emitter 20 and the fluorescent material in the ink formulation emits the light. The phototransistor of the photo sensor 22 receives the emission and possible reflection caused by the noise from the LED light emitter. The color filter filters this noise and sends the emission signal to the signal analyzer 24 to complete the ink identification. In the current examples, a voltage meter is used as the signal analyzer 24.

Inks:

### Example I

(1) Lexmark standard pigment black ink 1; (2) Lexmark standard pigment black ink 2; (3) Lexmark detectable black ink—Lexmark standard pigment black ink containing: 0.4% Fluo-white001 (Keyfluor White OB, invisible fluorescent dye from Keystone Aniline, processed in Lexmark as a stable dispersion); (4) Refill black ink 1; (5) Refill black ink 2; (6) Competitor's black ink 1; (7) Competitor's black ink 2; and (8) Competitor's black ink 3.

### Example II

(1) Lexmark standard magenta pigment ink; (2) Lexmark detectable magenta pigment ink—Lexmark standard magenta pigment ink containing: 0.4% Fluo-Green008 (Keyfluor Green OB-505, invisible fluorescent green dye from Keystone Aniline, processed in Lexmark as a stable dispersion); (3) Refill magenta ink 1; (4) Refill magenta ink 2; (5) Competitor's magenta ink 1; (6) Competitor's magenta ink 2; and (7) Competitor's magenta ink 3.

Results:

The fluorescent emission of the ink in the delivery tubing was measured as voltage signals using a phototransistor. In FIGS. 2 and 3, there is illustrated the voltage readings reflecting the existence of fluorescent materials in the inkjet inks, with the higher amounts of fluorescent material identifying the particular inks that gave higher voltage readings. The voltage readings given from the detectable inks are usually 1.5 to ten times greater than the readings from other inks. For example in FIG. 2, the signal from the detectable inks is about five times greater than the readings from other pigment or dye inks. The selected color filter #86 from the Roscolux filter book published by Rosco Laboratories Inc. was used to optimize signal to noise level of the detection. Lexmark detectable black pigment ink (FIG. 2) and Lexmark detectable magenta pigment ink (FIG. 3) can be easily detected from the ink delivery tubing.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. A system for identifying a particular inkjet ink, comprising:
an ink delivery tubing interconnecting an ink cartridge and a printhead;
a quantity of ink dispensing from the ink cartridge to the printhead by flowing through the ink delivery tubing;
a light emitter configured and positioned to transmit light in a first preselected wavelength bandwidth onto the ink delivery tubing and the ink flowing therethrough;
a photo sensor configured and positioned to detect light in a different second preselected wavelength bandwidth that is emitted by a fluorescent additive contained in the dispensed ink; and
a signal analyzer electrically connected to the photo sensor and operable to produce an electrical output signal corresponding to such light emissions such that an electrical output signal above a given level is indicative of the presence of the particular ink in the ink cartridge.

2. The system of claim 1 wherein said ink delivery tubing is made of a transparent plastic material.

3. The system of claim 1 wherein at least one of said ink delivery tubing, light emitter and photo sensor is supported in an inkjet printer.

4. The system of claim 1 wherein said fluorescent additive is a fluorescent dye or pigment having an excitation with UV or visible light in the wavelength range of 250 nm to 480 nm and have emission in the visible wavelength range from 400 nm to 780 nm.

5. The system of claim 4 wherein said fluorescent additive is a fluorescent dye or pigment being inorganic or organic material.

6. The system of claim 1 wherein said fluorescent additive is an invisible fluorescent material.

7. The system of claim 1 further comprising a filter adapted to absorb light in said first preselected wavelength bandwidth and pass light in said second preselected wavelength bandwidth.

8. The system of claim 1 wherein said light emitter is a light emitting diode having a peak wavelength approximately the same as an exciting wavelength of the fluorescent additive in the ink.

9. The system of claim 1 wherein said light emitting diode operates in a UV bandwidth.

10. The system of claim 1 wherein said photo sensor is a phototransistor with a filter adapted to absorb light in said first preselected wavelength bandwidth and pass light in said second preselected wavelength bandwidth.

11. A method for identifying a particular inkjet ink, comprising:
dispensing ink from an ink cartridge to a printhead by the ink flowing through an ink delivery tubing interconnecting the ink cartridge to the printhead;
transmitting light in a first preselected wavelength bandwidth onto the ink delivery tubing and the ink flowing therethrough;
detecting light in a different second preselected wavelength bandwidth emitted by a fluorescent additive contained in the dispensed ink; and
producing an electrical output signal corresponding to such light emissions such that an electrical output signal above a given level is indicative of the presence of the particular ink in the ink cartridge.

12. The method of claim 11 further comprising:
supporting the ink cartridge in an inkjet printer.

13. The method of claim 12 further comprising:
supporting the printhead in an inkjet printer.

14. The method of claim 13, further comprising:
supporting the ink delivery tubing in an inkjet printer.

15. The method of claim 14 further comprising:
supporting the light emitter in an inkjet printer.

16. The method of claim 15 further comprising:
supporting the photo sensor in the inkjet printer.

17. The method of claim 11 wherein said transmitting includes emitting light having a peak wavelength approximately the same as an exciting wavelength of the fluorescent additive in the ink.

18. The method of claim 11 wherein said transmitting includes emitting light in a UV bandwidth.

19. The method of claim 11 wherein said fluorescent additive is a fluorescent dye or pigment having an excitation with UV or visible light in the wavelength range of 250 nm to 480 nm and have emission in the visible wavelength range from 400 nm to 780 nm.

20. The method of claim 11 wherein said fluorescent additive is a fluorescent dye or pigment being inorganic or organic material.
